(19) United States
(12) Patent Application Publication
(10) Pub. No.: US 2009/0237193 A1
(43) Pub. Date: Sep. 24, 2009

(54) Multi-core inductive device and method of manufacturing

(76) Inventor: Timothy Craig Wedley, Barnaderg (IE)

Correspondence Address: GAZDZINSKI & ASSOCIATES, Suite 375, 11440 West Bernardo Court, San Diego, CA, 92127, US

(21) Appl. No.: 12/077,559

(22) Filed: Mar. 20, 2008

(51) Int. Cl. H01F 27/02; H01F 7/06

(52) U.S. Cl. 336/83; 29/606

(57) ABSTRACT

A multi-core inductive device assembly for electrical or electronic applications. In one embodiment, the device assembly comprises a multiple core component structure providing multiple inductive devices (for example, that has N inductors and two core elements). Conductive windings are disposed between the core elements. The core elements comprise risers for each of the inductive devices which permit, among other things, individual control of the gap formed between the risers, and hence the magnetic and other performance aspects of each inductive device. This topology allows for a multi-element (N) inductor array with substantial isolation properties, and which allows for individualized control of saturated output power performance for each of the N inductors. Methods for use and manufacturing are also disclosed.

### RELATED APPLICATIONS

This application is related to the subject matter of co-pending U.S. patent application Ser. No. 11/203,042 filed Aug. 12, 2005 and entitled “Stacked Inductive Device and Methods of Manufacture,” which claims priority to U.S. Provisional Application Ser. No. 60/600,985 filed Aug. 12, 2004, of the same title, both incorporated herein by reference in their entirety. This application is also related to the subject matter of co-pending U.S. patent application Ser. No. 11/213,461 filed Aug. 26, 2005 and entitled “Precision Inductive Devices and Methods”, also incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of Invention

The present invention relates generally to electronic elements and particularly in one exemplary aspect to an improved design and method of manufacturing miniature electronic components including inductive devices (e.g., inductors, “choke coils,” etc.).

2. Description of Related Technology

Conventional inductive components are electronic devices providing storage capability (i.e., storage of energy in a magnetic field) within an alternating current circuit. Inductors are one well-known type of inductive component, and are formed typically using one or more coils or windings, which may or may not be wrapped around a magnetically permeable core. So-called “dual winding” inductors utilize two windings wrapped around a common core.

Transformers are another type of inductive component that are used to transfer energy from one alternating current (AC) circuit to another by magnetic coupling. Generally, transformers are formed by winding two or more wires around a ferrous core. One wire acts as a primary winding and conductively couples energy to and from a first circuit. Another wire (wound around the core to be magnetically coupled with the first wire) acts as a secondary winding and conductively couples energy to and from a second circuit. AC energy applied to the primary windings causes AC energy in the secondary windings and vice versa. A transformer may be used to transform between voltage magnitudes and current magnitudes, to create a phase shift, and to transform between impedance levels.

Ferrite-cored inductors and transformers are commonly used in modern broadband telecommunications circuits to include ISDN (integrated services digital network) transceivers, DSL (digital subscriber line) modems, and cable modems. These devices provide any number of functions including shielding, control of longitudinal inductance (leakage), and impedance matching and safety isolation between broadband communication devices and the communication lines to which they are connected.

Ferrite-core inductive device technology is driven by the need to provide miniaturization while at the same time meeting performance specifications set by chip-set manufactures and standards bodies such as the ITU-T. For example, in DSL modems, micro-miniature transformers are desired that may allow a DSL signal to pass through while introducing a minimal THD (total harmonic distortion) over the DSL signal bandwidth. As another example, dual-winding inductors may be used in telephone line filters to provide shielding and high longitudinal inductance (high leakage).

### “Shaped” Devices

A common prior art ferrite-cored inductive device is known as the EP-core device. Other similar well-know devices include inter alia so-called EF, EE, ER, and RM devices. FIG. 1 illustrates a prior art EP transformer arrangement, and illustrates certain aspects of the manufacturing process therefore. The EP core of the device 100 of FIG. 1 is formed from two EP-core half-pieces 104, 106, each having a truncated semi-circular channel 108 formed therein and a center post element 110, each also being formed from a magnetically permeable material such as a ferrous compound.

As shown in FIG. 1, each of the EP-core half-pieces 104, 106 are mated to form an effectively continuous magnetically permeable “shell” around the windings 112, the latter that are wound around a spool-shaped bobbin 109, which is received on the center post element 110. The precision gap in ground on the ferrite post 110 may be engineered to adjust the transfer function of the transformer to meet certain design requirements. When the EP core device is assembled, the windings 112 wrapped around the bobbin 109 also become wrapped around the center post element 110. This causes magnetic flux to flow through the EP core pieces when an alternating current is applied to the windings. Once the device is assembled, the outer portion of the EP cores self-encloses the windings to provide a high degree of magnetic shielding. The ferrous material in the core is engineered to provide a given flux density over a specified frequency range and temperature range.

The bobbin 109 includes a terminal array 114 generally with the windings 112 penetrating through the truncated portions 116 of the half-pieces 104, 106, the terminal array 114 being mated to a printed circuit board (PCB) or other assembly. Margin tape (not shown) may also be applied atop the outer portions of the outer winding 112 for additional electrical separation if desired.

For each core shape and size, various differing bobbins are available. The bobbins themselves (in addition to the other elements of the parent device) have many different characteristics; they may provide differing numbers of pins/terminations, different winding options, different final assembly techniques, surface mount versus through-hole mount, etc.

Magnet wire is commonly used to wind transformers and inductive devices (such as inductors and transformers, including the aforementioned EP-type device). Magnet wire is made of copper or other conductive material coated by a thin polymer insulating film or a combination of polymer films such as polyurethane, polyester, polyimide (aka “Kapton™”), and the like. The thickness and the composition of the film coating determine the dielectric strength capability of the wire. Magnet wire in the range of 31 to 42 AWG is most commonly used in microelectronic transformer applications, although other sizes may be used in certain applications.

The prior art EP and similar inductive devices described above have several shortcomings. A major difficulty with EP devices is the complexity of their manufacturing process, which gives rise to a higher cost. The use of a bobbin (also called a “form” or “former”) increases not only the cost, but also size and complexity of the final device, since the bobbin is retained within the device upon completion of the manufacturing process. The bobbin consumes space within the device, which could be used for other functionality, or conversely eliminated to give the final device a smaller size and/or footprint.

In addition, the EP core half pieces themselves are relatively costly to mold and produce. For example, by the time the EP transformer is assembled and tested, its volume production cost is high (currently ranging from approximately $0.50 to-$0.70). It would be desirable to produce a device having performance characteristics at least equivalent to those of an EP transformer, but at a significantly lower cost.

It will also be appreciated that prior art core configurations such as the EP core are inherently inflexible because typically only one style or configuration of device that may be produced from the pre-formed core pieces (i.e., one cannot form a different or compound device from the core pieces) based on their orientation. In some applications involving EP cores, there is a need to minimize coupling between core pieces to meet a filter specification requirement.

Furthermore, multiple inductive devices need to be positioned in a compact, e.g., small restate area, to reduce packaging size to produce a low cost per square inch packaged device. Other applications for inductive devices include high power transmitters, transceivers, integrated circuit input and output matching as well as bias networks, and other radio frequency components for filter, amplifier, and microwave mixer designs.

In addition, conventional core configuration have highly optimized core shapes to obtain the required performance and to reduce an occupied volume, thus, these core configurations may incur high production/manufacturing costs. Furthermore, if there are multiple frequency ranges and/or inductor value requirements, these conventional core configurations may not prove a cost effective alternative and result in an unfavorable return on investment costs. Technical considerations for designing a multi-frequency band module using conventional core configurations may prove tricky because core performance in a first frequency band may significantly affect core performance in a second frequency band. Other technical considerations that prove challenging include a need to maintain power saturation conditions for each magnetic core that is a portion of a single module or a core array.

### Bonded Wire

Bonded wire is a well-established product/process used to produce so-called “air coils.” Air coils are inductors, and are typically used in RFID tags, voice coils, sensors, and the like. The materials and manufacturing equipment for producing bonded wire are commercially available from a variety of sources known to the artisan of ordinary skill.

Bonded wire is essentially an enamel-coated wire having additional coating applied (by either the wire vendor or the device manufacturer) to the outer surfaces of the enamel. During winding, the bonded wire coating may be activated (normally by heat, although other types of processes including radiation flux, chemical agents, and so forth) to cause the coated wires to stick/bond together. This approach provides certain benefits and cost economies in the context of electronic component production.

Accordingly, based on the foregoing, there is a need for an improved electronic device, and a method of manufacturing the device, that is both spatially compact and highly flexible in its implementation and configurations, and which provides sufficient magnetic isolation between individual inductive devices so as to permit, inter alia, the tuning of each device individually.

Ideally, such improved device would also allow for the use of substantially identical core elements, not require use of a bobbin, and would utilize existing and well understood formation and process technologies (such as e.g., bonded wire) in order to simplify the manufacturing process and further reduce cost, while maintaining the desired level of electrical performance.

### SUMMARY OF THE INVENTION

The foregoing needs are satisfied by the present invention providing improved inductive apparatus and methods for manufacturing the same.

In a first aspect of the invention, an improved inductive assembly is disclosed. In one exemplary embodiment, the assembly comprises multiple core elements arranged in a substantially face-to-face fashion so as to form two discrete and longitudinally arranged inductive devices (e.g., inductors, transformers, choke coils, etc.). Identical core elements are used in this embodiment in order to, inter alia, simplify construction and reduce cost. In one variant, bonded windings are used (i.e., without any bobbin or similar structure) in order to simplify the assembly and reduce cost and size. Portions (i.e., risers) of the core elements are separated by gaps to, among other things, increase magnetic isolation between the individual inductive devices while providing the desired electrical and mechanical performance.

In a second embodiment, the assembly includes an internal wall or riser disposed between the two individual inductive devices to magnetically isolate them from one another.

In a third embodiment, the assembly comprises two asymmetric core elements (e.g., one core element with risers, and a second element comprising merely a plate or substantially planar surface).

In a fourth embodiment, multiple inductive devices are formed within the assembly in both longitudinal and transverse directions; e.g., “row and column” so as to form an array.

In a fifth embodiment, one or more additional core elements are stacked in a face-to-back orientation with one of the two aforementioned core elements (that are face-to-face), and windings included therewith, so as to form yet additional inductive devices within the assembly.

In a second aspect of the invention, an inductive device including a bobbin or header is disclosed. In one embodiment, the header comprises a termination header having a plurality of terminations associated therewith. The core elements and windings are contained at least partly within a plastic or other header assembly that facilitates mating of the device to an external device (e.g., PCB). In one variant, the header is self-leaded; i.e., does not require separate conductive terminals. In another variant, the header contains multiple inductive device assemblies in a linear row or column. In still another variant, a bobbin is used around which at least a portion of the inductive device windings are wound, and which also provides for external termination.

In a third aspect of the invention, a method of manufacturing the above-referenced electronic device is disclosed. In one embodiment, a plurality of core elements is provided. A plurality of winding elements is coupled to the plurality of core elements. Each of the winding elements has been formed into a predetermined shape to comprise a substantially unitary body. The winding elements and the plurality of core elements are assembled so that the winding elements are each at least partly contained within a respective cavity that is provided around the plurality of core elements. In one embodiment, the plurality of core elements are located on a half-core device.

In another embodiment, the method comprises: providing a plurality of core elements; providing a plurality of winding conductors; forming the winding conductors into substantially unitary winding elements, the elements substantially retaining their shape after the forming without a bobbin or support structure; disposing the plurality of winding elements to the plurality of core elements so that the winding elements are each at least partly contained within a respective cavity that is formed around at least a portion of the plurality of core elements; and coupling each of the plurality of core elements to at least one other of the plurality of core elements.

In a fourth aspect of the invention, an improved “direct mount” inductive device is disclosed. In one embodiment, the device comprises a form-less inductive device as previously described, yet which mates directly with the parent assembly (e.g., a PCB substrate), thereby obviating the termination header. In one variant, the windings are terminated to surface-metallized pads formed on the device exterior. In another variant, free ends of windings protrude from the device through an aperture formed in an underlying assembly. The free ends are soldered to conductive pads formed on the PCB substrate.

In a fifth aspect of the invention, a method of operating an inductive device is disclosed. In one embodiment, the device comprises a multi-inductor device, and the method comprises: providing an inductive device comprising a plurality of core elements which form a plurality of gapped opposing surfaces, the gapped opposing surfaces being associated with respective ones of the inductors; generating a first flux through the device including across a first of the gaps, the generated first flux being in a first direction; and generating a second flux through the device including across the first gap, the generated second flux being in a second direction. The first and second fluxes flow in the same direction through the first gap.

In one variant, the method further comprises: generating a third flux through the device including across a second of the gaps, the generated third flux being in the second direction; and generating a fourth flux through the device including across the second gap, the generated fourth flux being in the first direction. The third and fourth fluxes flow in the same direction through the second gap.

In a sixth aspect of the invention, an inductive device having a plurality of inductive elements is disclosed. In one embodiment, the device comprises: a first core element; a second core element; and at least two winding elements. The first and second core elements form at least two gapped risers, respective ones of the at least two winding elements being substantially disposed around the at least two gapped risers.

In one variant, the winding elements each comprise bonded wire windings formed into a substantially unitary body.

In another variant, the device comprises a plurality of flux paths when operated, the plurality of paths including substantially parallel paths of common direction through each of the at least two gapped risers. The core elements may also further form a non-gapped or bridged riser, and the plurality of paths include another path through the non-gapped or bridged riser which is substantially parallel with, but of opposite direction to, the paths of the at least two gapped risers.

In a seventh aspect of the invention, a multi-inductor inductive device is disclosed. In one embodiment, the device comprises: a plurality of core elements, the core elements comprising a plurality of risers, at least a portion of the risers comprising a gap; and a plurality of windings, the windings disposed at least partly around respective ones of the risers. The inductors are substantially electrically isolated from one another, the isolation allowing for individualized determination of saturated output power for each of the plurality of inductors.

### BRIEF DESCRIPTION OF THE DRAWINGS

The features, objectives, and advantages of the invention will become more apparent from the detailed description set forth below when taken in conjunction with the drawings, wherein:

FIG. 1 is an exploded perspective view of a typical prior art “EP” type inductive device.

FIG. 2a comprises exploded perspective view of a two-device (e.g., inductor) embodiment of the inductive assembly of the invention.

FIG. 2b comprises a side view of the embodiment of FIG. 2a of the invention, depicting flux lines associated therewith.

FIG. 2c comprises a side view of a two-device embodiment having an internal wall.

FIG. 3a comprises a perspective view of a two-inductor embodiment of the invention.

FIG. 3b comprises a perspective view of a two-inductor embodiment of the device having with an internal wall, according to the invention.

FIG. 3c comprises a half-core perspective view of a four-inductor embodiment (with an internal wall).

FIG. 3d comprises a half-core perspective view of a three-inductor embodiment of the invention.

FIG. 4 comprises a perspective view of a four-device array embodiment of the invention.

FIG. 5a comprises a partially and fully assembled perspective view of another embodiment of the invention utilizing juxtaposed rows of inductive devices.

FIG. 5b comprises a partially and fully assembled perspective view of another embodiment of the invention, wherein an asymmetric core element geometry is utilized.

FIG. 5c comprises a partially and fully assembled perspective view of another embodiment of the invention utilizing heterogeneous “stacked” core elements.

FIG. 6a comprises a perspective view of various bobbin and termination header arrangements useful with the inductive device of the invention.

FIG. 6b comprises a perspective view of an exemplary lead frame mounting arrangement used on the inductive device of the invention.

FIG. 6c comprises a perspective view of an exemplary self-leaded (header-less) termination arrangement used on the inductive device of the invention.

FIG. 7 comprises a logical flow diagram illustrating an exemplary embodiment of the method of manufacturing the device of the invention.

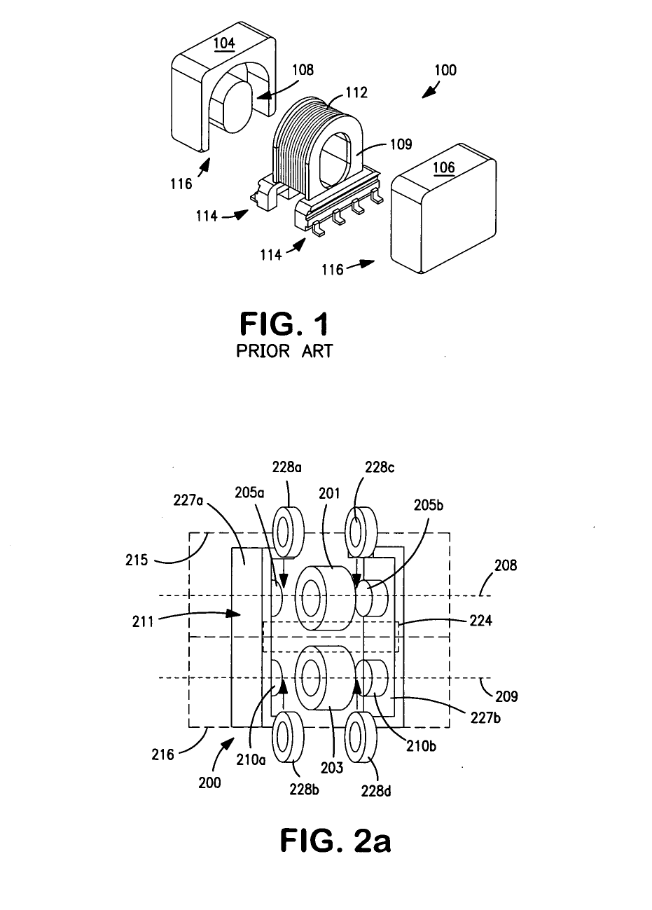

### DETAILED DESCRIPTION OF THE INVENTION

Reference is now made to the drawings wherein like numerals refer to like parts throughout.

As used herein, the term “magnetically permeable material” refers to any number of materials commonly used for forming inductive cores or similar components, including without limitation various formulations made from ferrite.

As used herein, the term “winding” refers to any type of conductor(s), irrespective of shape, cross-section, material, or number of turns, which is/are adapted to carry electrical current.

### Overview

In one salient aspect, the present invention provides improved multi-core inductive electronic assembly and methods for producing the same. One significant benefit of the present invention is high cost efficiency for a corresponding high level of electrical performance, as well as spatial compactness (i.e., the device may be made smaller in size and/or footprint). This is achieved to some degree by decoupling or substantially isolating the flux paths through different constituent devices that make up the inductive assembly.

In effect, a compact, high performance and low-cost inductor assembly is provided by combining numerous cores and coils together within a single form factor. In one exemplary configuration, the core elements are purposely made identical (i.e., are the same production component, albeit often not perfectly identical), thereby allowing for the purchase of larger lots of core elements (and hence allowing for a lower manufacturing cost). Form-less (i.e., bobbin-less) bonded windings are also used in one embodiment in order to further reduce device complexity, cost, and size.

The individual core elements may advantageously be arranged in any number of different ways including, without limitation (i) in a face-to-face co-linear orientation; (ii) in a face-to-back or stacked collinear orientation; (iii) in an orthogonal orientation; and (iv) combinations of the foregoing. They may also be used for application such as coupled inductors.

### Exemplary Apparatus

It will be recognized that while the following discussion is cast in terms of an exemplary multi-ferrite core device, the invention is equally applicable to other core configurations and even other types of inductive devices. Conceivably, any device having a plurality of winding turns and a magnetically permeable core (or comparable structure) may benefit from the application of the approach of the present invention. Accordingly, the following discussion of the inductive device is merely illustrative of the broader concepts.

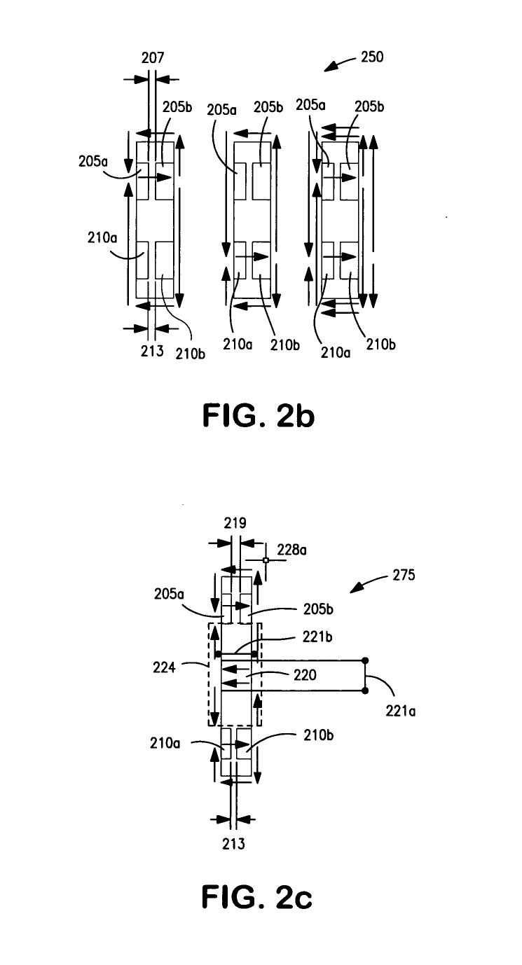

FIG. 2a comprises exploded perspective view of a two-inductor embodiment of the invention. Referring to FIG. 2a, the inductive device 200 comprises a first winding element 201, a second winding element 203, and first, second, third, and fourth core elements 205a, 210a, 205b, 210b into which the winding elements 201, 203 are assembled. The device is generally held together when assembled using an adhesive or epoxy; however, it will be appreciated that other methods such as clips, frictional or interference pin/hole arrangements, etc. may be used if desired. Adhesive/epoxy has the advantages of low cost and simplicity.

The core elements are fashioned from a magnetically permeable material such as e.g., a soft ferrite or powdered iron as is well known in the electrical arts. The manufacture and composition of such cores is well understood, and accordingly is not described further herein.

Each of the winding elements 201, 203 may comprise a single winding (single strand, bifilar, or otherwise), or alternatively may comprise multiple windings. Such multiple windings may be in the form a unitary structure (such as where the windings are bonded together, interwoven, or bifilar) or may alternatively comprise two or more substantially discrete winding elements (such as, e.g., two winding “toroids” placed immediately adjacent one another between the two core elements). The windings may also be insulated (such as by using Kapton™ polyimide or another type of insulation), comprise so-called “magnet wire,” or comprise any number of different conductor configurations.

For example, in one variant, the bonded wire comprises 35 AWG-42 AWG bondable wire manufactured by the Bridgeport Insulated Wire Company of Bridgeport, Conn., although other manufacturers, configurations, and sizes of wire may be used. This wire comprises round copper magnet wire with a polyurethane base coating. The polyurethane base coat has a polyamide (Kapton) and self-bonding overcoat. The wire of the illustrated embodiment may be made to comply with relevant electrical standards (e.g., with the NEMA MW29-C and IEC 317-35 international standards for wire), although this is not required in any fashion

In the exemplary embodiment, the first and second winding elements, e.g., 201 and 203, comprise “form-less” windings of the type described in co-pending and co-owned U.S. patent application Ser. No. 10/885,868 filed Jul. 6, 2004, entitled “Form-less Electronic Device and Methods of Manufacturing” incorporated herein by reference in its entirety, although other approaches may be used as well. The form-less windings have the advantage of low cost and lack of a former or bobbin, thereby reducing their spatial profile considerably while maintaining the desired electrical performance.

While bonded wire is preferred, the device 200 may also utilize wound coils formed and coated as described generally in U.S. Pat. No. 6,642,827 to McWilliams, et al. issued Nov. 4, 2003 and entitled “Advanced Electronic Miniature Coil and Method of Manufacturing,” which is incorporated herein by reference in its entirety. Specifically, a Parylene coating is applied to a plurality of individual wires formed into a layer or group using for example a vapor or vacuum deposition process. Parylene is chosen for its superior properties and low cost; however, certain applications may dictate the use of other insulating materials. Such materials may be polymers such as for example fluoropolymers (e.g., Teflon, Tefzel), polyethylenes (e.g., XLPE), polyvinylchlorides (PVCs), or conceivably even elastomers. Additionally, dip or spray-on coatings may be used to form the winding elements 102, 104 of the illustrated invention.

Furthermore, as shown in FIG. 2a, the first and second windings 201, 203 may be heterogeneous including having a different geometry, e.g., different overall thickness (i.e., as measured longitudinally along each of the central axes 208, 209 of the windings), different radius, different winding type, etc.

It will also be appreciated that while the embodiment of FIG. 2a shows windings which are substantially toroidal (i.e., donut-shaped) in form, they may also have other geometries, such as being in a substantially oval form. For example, the form may be that of that used with prior art shaped “E” cores (e.g., EP, EP-7 “tall cores,” EF, EE, and RM, and even pot core) of the type well known in the art.

Specifically, since inductors are DC energy storage devices, they are governed by their inductance and the DC current being applied. Prior art devices using ferrite cores only allow for small amounts of energy to be stored within the component before the ferrite material magnetically saturates. It is noted that ferrite has been developed and applied primarily in AC applications (e.g. transformers). To improve the energy storage capability, an air-gap is introduced into the core shape, typically on the center leg (or around the periphery of a toroid core), where the energy is stored in the form of DC magnetic flux. When the DC magnetic flux becomes sufficiently large, the inductor will again be seen to saturate and cease to have an inductive character. Hence, the ferrite core operates primarily as a path for the flux to enter the air-gap.

Because the ferrite provides a path through the gap, it is possible to form part of the path by using the core of another inductor. Advantageously, the multi-ferrite approach of the present invention takes advantage of this feature, in effect using pairs of core elements, e.g., pieces, as part of the induction path for the inductor(s). At least two separate gaps (for two inductors) are required for this approach, and the gaps of the respective devices must not significantly interact. A first half-core plate 227a and a second half core plate 227b form return paths for the flux of the coil of a first and a second inductive device; therefore, this core configuration provides both an operating environment and separation, e.g., isolation, mechanism (as illustrated by the flux lines depicted in FIG. 2b and will be explained further below).

A significant aspect of the device 200 (in FIG. 2a) is the use of multiple inductive devices 215, 216 with multiple core elements, e.g., core pieces 227a, 227b. In the illustrated embodiment, these two core elements 227 each comprise substantially planar elements 211 with two risers 205, 210; i.e., two per inductor 215, 216. For example, the inductive device 215 includes: (i) a planar element 211 with two end “legs”; (ii) the first and third core “risers” 205a, 205b; and (iii) the first winding element 201 (shown in FIG. 2a and has been omitted from FIG. 2b to ease viewing flux lines).

Referring to FIG. 2b, the inductive device 215 provides a magnetic flux path, e.g., a first inductive leg (note that inductive windings 201 and 203 have been removed from FIG. 2b to better illustrate the flux line paths of the first and second inductive devices 215, 216). The first inductive leg includes flux lines that electromagnetically couple from the first core riser 205a through a first gap 207, through the third core riser 205b, and back (return) to the first core riser 205a. Thus, the inductor topology of the first inductor device 215 (shown in FIG. 2a) substantially avoids the flux path through the gap between the second core riser 210a and the fourth core riser 210b.

Referring again to FIG. 2b, the other inductive device 216 includes the planar portion with legs, second and fourth core risers 210a, 210b, and the second winding element 203 (shown in FIG. 2a and has been omitted from FIG. 2b to ease viewing flux lines). The inductive device 216 provides magnetic flux path, e.g., a second inductive leg. The second inductive leg includes flux lines that electromagnetically couple from the second core riser 210a, through a second gap 213 through the fourth core riser 210b, and back (return) to the second core element 210a. Thus, the inductor topology utilized for second inductor device 216 (shown in FIG. 2a) substantially avoids the flux path through the gap between the first and third core risers 210a, 210b.

Furthermore, the flux lines of the first inductive device 215 and the second inductive device 216 may be further isolated by the addition of e.g., an internal ungapped bridge or wall 220 (as shown in FIG. 2c) within the channel 224. This acts to further reduce cross-coupling of the magnetic flux lines (and cross-talk between the first and second inductive devices 215, 216). For example, in one embodiment of the device, cross-talk is advantageously mitigated up to approximately 30 MHz, which is important for many VDSL2 applications.

The bridge or wall 220 may comprise another (e.g., third) riser on each of the respective core elements 227a, 227b which meets with the other riser to form a gapless union when the device is assembled, similar to those used to form the gapped pathways previously described. It may literally be any shape or cross-section (although a round or circular cross-section is shown in the illustrated embodiment). The thickness 221a and the width 221b of the internal feature 220 may be chosen to meet the desired performance goal(s); e.g., decrease signal cross coupling (e.g., cross talk) between the inductive devices 215, 216. Thus, a high level of magnetic isolation may be maintained between the devices 215, 216 (shown in FIG. 2a), whether with or without the internal bridge or wall.

Another advantage the internal bridge or wall 220 may include reducing cavity mode resonances, e.g., undesired magnetic flux or current mode resonances, such that may occur within the channel 224 between the devices 215, 216. The thickness 221a and the width 221b of the feature 220 may also be selected to eliminate or decrease undesirable resonant modes so as to enhance or improve performance in a selected frequency range. It will also be appreciated that the diameter of the risers 205, 210 can be adjusted along with the gap (i.e., the surface area of face of each riser) in order to vary the coupling characteristics across each gap. The foregoing dimensions (i.e., gap width, riser area, channel size, wall dimensions, etc.) may be readily optimized by those of ordinary skill for the particular device application and parameters provided the present disclosure (whether manually, by computer simulation, or another approach); accordingly, the particulars of this optimization process are not discussed further herein.

Furthermore, the addition of the internal bridge or wall 220 increases mechanical stability and strength of the device 200 as a whole.

A design advantage of the illustrated topology of FIG. 2a includes the ability to individually adjust the gaps 207, 213, providing the unexpected result of increasing/decreasing inductance of the first and second inductive devices 215, 216 while at the same time minimally affecting signal isolation levels of the devices 215, 216. Furthermore, this topology provides first and second gaps 207, 213 that are individually adjustable so as to permit adjustment of the saturated output power of the first and second inductive devices 215, 216.

Additionally, because the devices 215, 216 are substantially isolated from one another in terms of magnetic field, an array of inductive devices may advantageously be created, the constituent inductive devices which may be individually tuned (or even turned-off or turned-on), each within a different desired frequency range or selected saturated output power level if desired.

As shown in FIG. 2a, the two core elements 227a, 227b (and hence the first, second, third, and fourth core risers 205a, 210a, 205b, 210b) of the illustrated embodiment are substantially identical in form, and are disposed in a face-to-face (symmetric) configuration with each other. This approach advantageously allows for the device 200 to be made using identical core pieces if desired, thereby reducing the cost and labor associated with forming heterogeneous pieces. This simplifies stocking, manufacturing, distribution, inventory, and any number of other facets of the supply chain.

It is also noted that the core pieces have no chirality or “handedness” from the standpoint that any of the core pieces may be used in place of the others, and in effectively any orientation. Hence, there is no “up/down” or “left/right” distinction between the core pieces. This greatly simplifies assembly since the core components (and even the winding elements) may be assembled in multiple orientations; i.e., a machine or manual assembler need not look at each piece selected and orient it properly before assembly; there is more than one possible “correct” orientation of the two elements.

The size of the gaps may be controlled readily through machining or forming processes of the type well known in the art. Specifically, in a face-to-face orientation such as that of FIG. 2a, the height of the outer legs of each core piece and the height of the risers 205, 210 each determine the relative spacing of the riser faces. These parameters can be controlled as desired (as well as through control of the thickness of the planar portions of each core element for the interior cavity height). Moreover, “residue” gaps or other features of the type described in co-owned and co-pending U.S. patent application Ser. No. 11/213,461 filed Aug. 26, 2005 and entitled “Precision Inductive Devices and Methods”, incorporated herein by reference in its entirety, may be used consistent with the present invention to provide desired gap or other inductive device characteristics.

The core elements 227a, 227b may optionally include riser spacer elements 228a-d (FIG. 2a), which in this embodiment are configured to fit around respective ones of the risers 205, 210 so as to permit formed or bonded winding positioning. In one instance, the configuration and electrical properties desired may be obtained by controlling the height of this spacer (i.e., how far it extends in height along a central axis, e.g., 208 or 209) for each riser. This allows for adjustment of the position of the bonded windings relative to the gap (and core elements 227), such as where it may be desired to: (i) use windings which have an overall height which is substantially less than the height of the cavity created between the interior surfaces of the two opposing core elements 227; and/or (ii) position the windings within the aforementioned cavity; e.g., at a location symmetric to the gap, or alternatively one not symmetric to the gap (i.e., offset to one side or another).

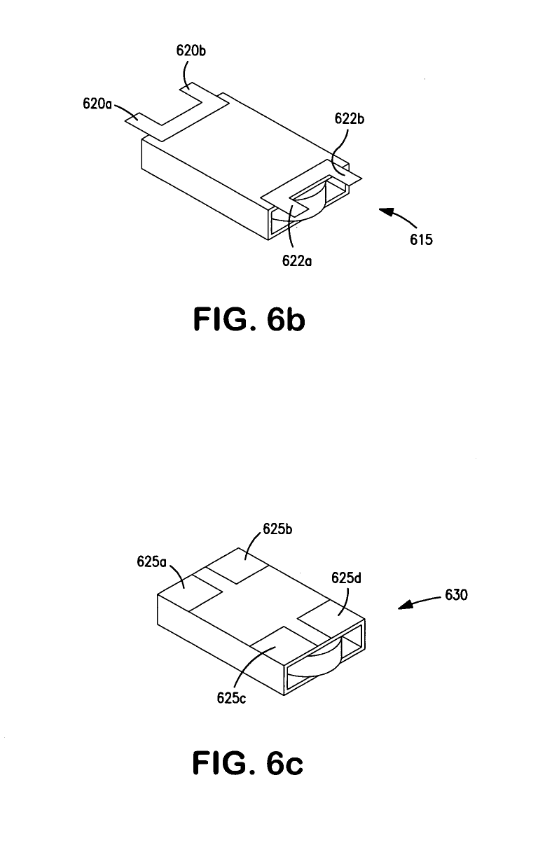

Moreover, it will be appreciated that the core elements 227 of the invention may be used with a bobbin-type arrangement, which may or may not include a terminal array (see discussion of FIG. 6a subsequently herein). For example, in one variant, the former-less (bonded) windings previously described are replaced with non-bonded windings that are wrapped around a former or bobbin (e.g., plastic spool piece). In one variant of this arrangement, the bobbin also includes a terminal array of the type shown in FIG. 6a, thereby allowing for positioning and termination of the device to a substrate. As with the spacer elements 228 previously described, the bobbin if used may also be configured to position the windings relative to the core elements 227 and gap(s) between the relevant risers.

The “adjustable” gap design of the present invention provides a system designer with the capability to tune electrical performance of core elements on an individual and/or on a paired basis. For instance, saturated output power and/or frequency range may be tuned for the inductive devices 215, 216 individually and/or for the assembly as a whole.

It will also be recognized that the core element geometry relative to the diameter of the windings (as wound) may be varied. As shown in FIG. 2a, the winding diameter may exceed the profile of one or more dimensions of the core elements, such as where the device 200 is surface mounted with the exposed windings oriented upward (away from the PCB or substrate). Such effect may be achieved by offsetting the center leg of each core sufficiently to accommodate the winding within the profile of the core elements on one side (i.e., the PCB side), while allowing the other side of the winding element(s) to protrude over the top of the core elements. Alternatively, the core elements can just be sized sufficiently to encompass the entire diameter of the windings, or the device can be mounted flat on its top or bottom (i.e., windings disposed parallel to the substrate on which the device is mounted. Hence, the core elements may advantageously be shaped in literally any configuration relative to the winding element dimensions. This may have not only practical implications in terms of position and orientation on the PCB, but also may be used to affect or shape the magnetic flux profile (and to some degree even the electrical performance) of the device.

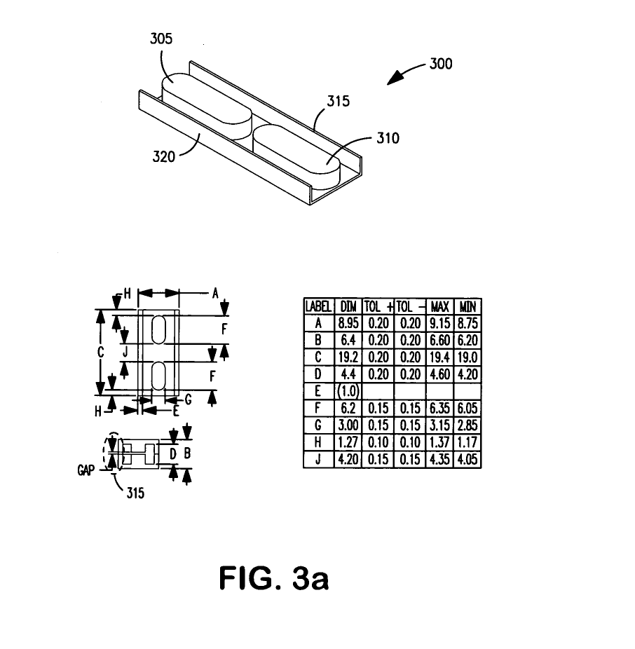

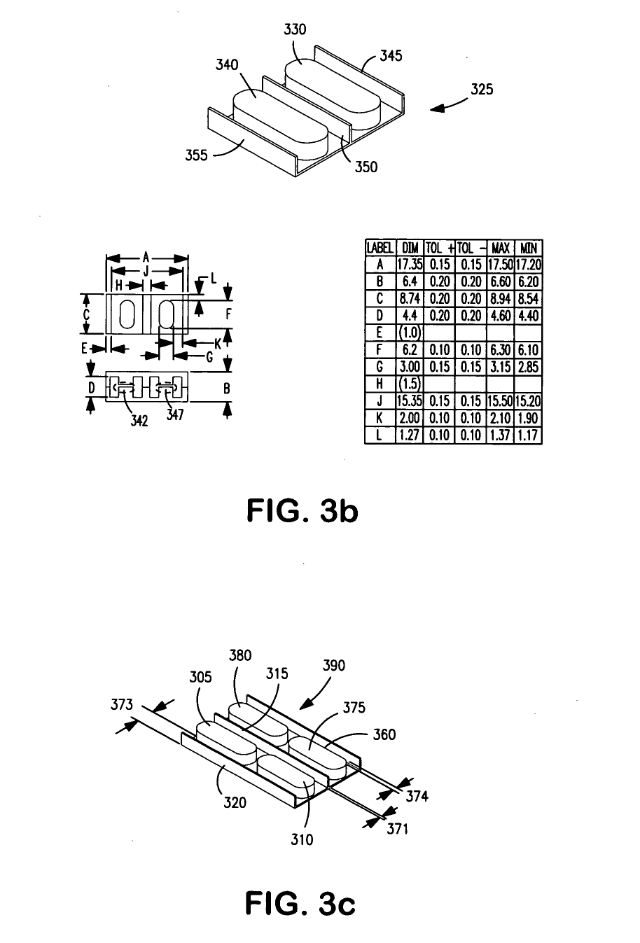

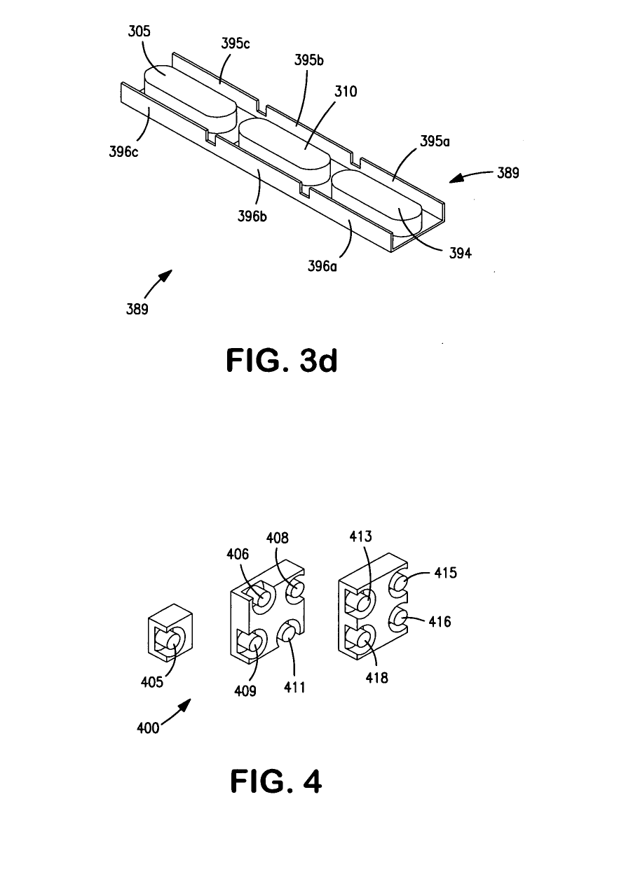

FIG. 3a illustrates another embodiment of the invention, wherein elongated risers 305, 310 are used, and the contact “legs” of the core element(s) 315, 320 are disposed laterally to the risers and planar elements (as opposed to at the ends of the planar elements 211 as shown in FIG. 2a).

FIG. 3b illustrates yet another embodiment of the invention, wherein elongated risers are used, and the contact “legs” of the core element(s) are disposed laterally to the risers and planar elements, yet the two core elements are effectively juxtaposed (i.e., in a side-by-side orientation). A central dividing wall 350, which is thicker than the two outer walls or legs 345, 355 is also provided to give enhanced separation or isolation of the devices, as well as provide mechanical stability.

The modular or “isolated” approach of the invention also allows for extension of the number of inductors of the device in multiple dimensions; see, e.g., the juxtaposed core element and risers 380, 375 of the device of FIG. 3c are effectively a combination of the embodiments of FIGS. 3a and 3b.

As illustrated in FIG. 3d, the addition of one or more inductive devices 394 (e.g., to the topology of FIG. 3a) may occur on an end of the inductive device 389, or even on the top and bottom faces (not shown).

It is further recognized that the inductive assembly of the present invention may take any number of different forms or configurations in terms of its shape, including substantially square, circular, or polygonal form, depending on the needs of the particular application. This is true not only of the outer shape, but also of the core interior surfaces as well. In particular, the multiple core approach may be applied to most core shapes, such as the EP core shape, as shown in FIG. 4, which may be formed into e.g., different types of quad packages from the basic “EP” shape (shown at left of FIG. 4).

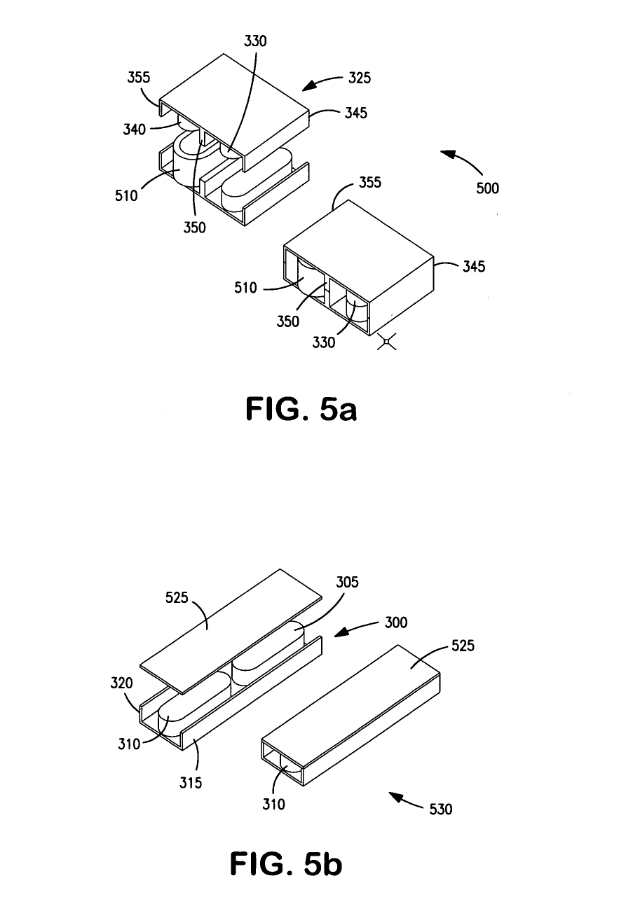

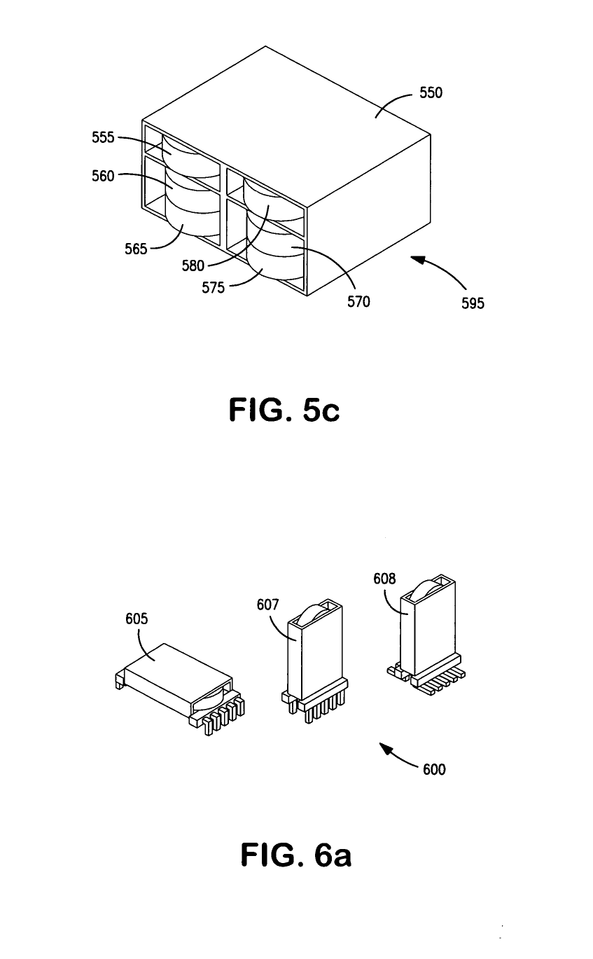

FIG. 5a illustrates an exemplary assembled implementation of the device of FIG. 3b. More specifically, the winding 510 is assembled within two substantially identical core elements (where each of the elements 325 is shown in FIG. 3b).

In yet another example, FIG. 5b displays an inductive device 530 having a core element with external sidewalls and a top plate 525 (e.g., I-plate). The top plate 525 is in one embodiment marginally wider and longer than the core element to ensure a good mechanical joint (and flux path) is formed. It will also be recognized that the profile and volume of this plate-based device is lower than that of other embodiments (i.e., those having two substantially identical or substantially symmetric core elements facing one another); however, there is also less magnetically permeable material in the device, and hence its inductive properties are different. Moreover, the gap is not positioned symmetric within the core, but rather is disposed proximate the plate 525, thereby making the flux profile asymmetric.

The technology of the present invention may be used in conjunction with, inter alia, the technology disclosed in U.S. patent application Ser. No. 60/600,985 filed on Aug. 12, 2004 previously incorporated by reference herein; i.e., a stacked approach using multiple core elements in face-to-back orientation.

FIG. 5c illustrates yet another embodiment of the invention, wherein a combination implementation of a face-to-face two core-element arrangement (as shown in 5a), and a single core element in a face-to-back orientation, is used. The single core element is disposed atop the assembled two-element device, and a half-height winding used accordingly. For instance, magnetic and/or material properties for the various core elements and windings 555, 560, 565, 570, and 575 may be individually or collectively chosen to achieve desired performance criteria. Such desired performance criteria may include for example the inductance value, reactance value, real or complex impedance, operating frequency range, and saturated output power level.

In summary, system variables of inductor winding(s) in combination with gap spacing advantageously allow a designer to realize an inductor array that may satisfy multiple filter/electronic component requirements. Magnetic flux paths may be realized utilizing one or more core pieces, e.g., elements, using a multitude of geometries. As such, the embodiments of FIGS. 2a-5c are only illustrative of the broader concepts.

It will also be recognized that methods of precisely controlling the electrical and magnetic performance of the inductive devices disclosed herein may be used, including control of the gap thickness and properties, as well as the placement of the gap relative to other components within the device.

The multi-ferrite device disclosed herein (as well as other embodiments) may advantageously be used with most any kind of termination header or structure, or without one as well. For example, a molded plastic header or carrier of the type well known in the art (not shown) adapted to receive at least a portion of the device may be used, such as to form an array or assembly of several individual multi-ferrite modules (each having two or more constituent inductive devices). This header may also be used to house other components besides the modules themselves if desired.

In this example, conductive terminals on or within the header may be used to interface to the pads on a PCB or other external device, as well as to the inductive device windings described above. An exemplary header or termination element includes plurality (e.g., ten connection points on each) of terminals; see e.g., the exemplary configuration of FIG. 6a. Furthermore, these terminals may be of literally any configuration, including for example, substantially rectangular cross-section adapted for surface mount (SMT), circular or elliptical cross-section for through-hole mounting, ball-grid array, etc. The terminals of the header (if used) may also be notched or shaped to facilitate wire wrapping if desired.

Additionally, the exact placement of the terminals within the header may be optimized based upon circuit placement and mounting considerations at the device or system level.

Furthermore, it will be appreciated that the header may comprise a self-leaded arrangement (see FIG. 6b). These type of headers are described in co-owned U.S. Pat. No. 5,212,345 to Gutierrez issued May 18, 1993, entitled “Self leaded surface mounted coplanar header,” or U.S. Pat. No. 5,309,130 to Lint issued May 3, 1994, entitled “Self Leaded Surface Mount Coil Lead Form”, both of which are incorporated herein by reference in their entirety. For example, in one embodiment, the header is a molded polymer device multiple self-leading terminals or “posts” formed therein, upon which several of the conductors of the winding elements 201, 203 are wound.

As shown in FIG. 6b, an alternative to a bobbin or header termination is a lead frame package that is attached (e.g., by gluing) directly onto the module using for example connection points 620a, 620b, 622a, and 622b, and being positioned in a variety of locations either pre-assembly or post-assembly. These terminations are easily identified and controlled by a user of the device.

In another variant, the conductive terminals may be bonded directly to the core elements 205a, 205b, 210a, 210b such as with a compound such as a silicone rubber encapsulant, or electronics epoxy. This approach obviates the cost and space associated with the header.

Similarly, a metallization process can be used to coat or form a layer (e.g., by deposition, electroplating, etc.) on the surface of portions of one or more of the core elements so as to permit “self-leading”. The core elements may even be shaped in this regards so as to facilitate self-leading (for example, by including features that enhance the self-leading metallization and bonding process). See, e.g., co-pending U.S. patent application Ser. No. 11/231,486 filed Sep. 20, 2005 entitled “Simplified Surface-Mount Devices and Methods”, incorporated herein by reference in its entirety, which discloses exemplary self-leading processes and configurations.

Referring to FIG. 6c, tack or direct soldering is shown and may be utilized for fitting and direct bonding of bobbin-less components (at pads 625a-d) onto at least one contact pad on a printed circuit board (PCB). Cores with silvered terminations are provided so that the lead wires may be tack soldered directly to these, avoiding the need for extra expense and processes of using a lead frame. This technique may be useful for example for two-wire inductor applications.

Core assembly (i.e., mating the core elements/plates together) may be carried out by a multitude of methods. Some of the core assembly methods include e.g., taping using several layers of a suitable tape material (e.g., one rated for sufficient temperature and life), and gluing to form a stacked core by bonding face-face using a suitable epoxy resin/glue to bond two cores together with sufficient strength. Other core assembly methods which may be used consistent with the invention include bridge-bonding using an epoxy/glue between core legs (risers) to reduce air-gap space, and/or over top of the core joints, and core taping with bridge bonding for larger stacked components (e.g., taping the cores together first, and afterwards bridge-bonding over the uncovered areas of the core).

Yet another assembly method may comprise clipping and capping to hold together the cores, which may in some instances require some bridge-bonding or another mechanism to ensure that the clip (such as a simple band, U-clip, etc.) stays in position. The core elements can also be formed or machined with grooves, recesses, etc. to facilitate the aim of maintaining the core elements in the desired orientation.

Yet other approaches for bonding the core elements may be feasible as well, such as laser or ion-beam welding.

The multi-ferrite approach of the invention may also be applied to “low profile” technologies such as, for example, that described in U.S. patent application Ser. No. 10/885,868 filed Jul. 6, 2004, previously incorporated by reference herein. Specifically, the aforementioned protrusion of the winding elements may be made to face the PCB or substrate to which the device 200 is mounted, and cooperating with an aperture or recess formed in that PCB or substrate. The leads of the device 200 may be routed on the same side of the PCB as to which the device is mounted, or alternatively may be routed through the aperture and terminated on the other side of the PCB. To reduce size, a self-bonded wire coil may be utilized; however, the disclosed topology even with the bobbin design may have possible to meet tighter size limitations.

It will be appreciated from the foregoing that benefits of the present invention include, inter alia:

(i) a reduction in overall size of the device as compared to traditional configurations, and a higher density of components (especially when using “bonded” winding approaches such as those previously described);

(ii) the ability to use identical core element(s) for many or all device configurations to reduce cost, labor, and volume dimensionality;

(iii) a degree of self-shielding afforded by the gapped core configuration (with optional internal bridge or wall) so that cross talk between the winding elements is mitigated;

(iv) the stacked approach described herein may be utilized with nearly all standard or non-standard core shapes, and hence is largely independent of or agnostic to core-shape;

(v) the assembly is highly scalable in terms of number of individual constituent devices;

(vi) different core types and component configurations may be mixed together (with proper adaptation to ensure that the various magnetic paths created within the composite device are compatible and the desired electrical performance is maintained); and

(vii) the assembly can be used for many magnetic applications (including for example and without limitation DSL applications, power magnetics, such as for SMPS and the automotive industry, etc.).

It is noted that the benefit in size reduction may be quite significant when the stacking arrangement of the present invention is coupled with the self-bonded winding arrangement of U.S. Ser. No. 10/885,868 filed Jul. 6, 2004, previously incorporated herein. However, even when the stacking arrangement is used with a bobbin or spool-based design, a smaller size none-the-less results as compared to the prior art.

The inductive device of the present invention finds use in any number of different applications where two or more inductors are required (especially those where surface mount footprint and/or overall device volume are limited or critical). One such exemplary application comprises DSL splitters, wherein multiple lightweight and compact yet high-performance inductors are desired.

### Method of Manufacturing

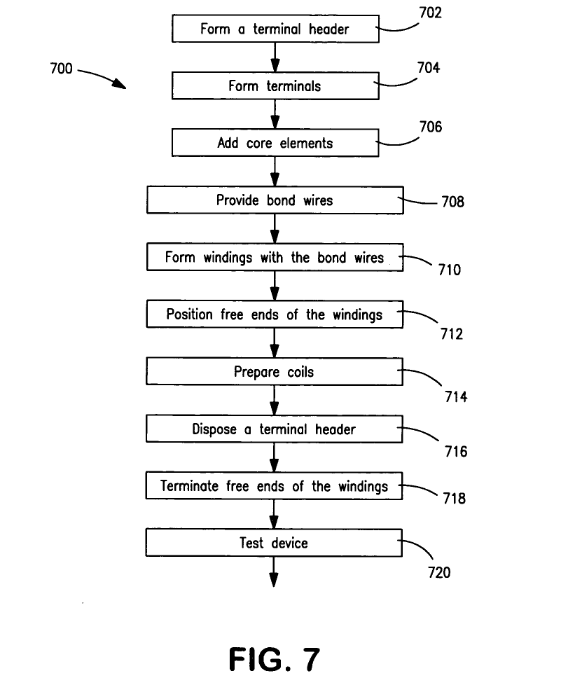

FIG. 7 illustrates one exemplary method 700 of manufacturing the inductive device of FIGS. 2a. It will be appreciated that while various steps are described in terms of forming or manufacturing components of the inductive device 200, such steps may be obviated by alternatively procuring the pre-manufactured component from a third party.

Furthermore, while the following is cast in terms of the device 200 of FIG. 2a, the method described herein is readily adapted by those of ordinary skill to other variants and embodiments of the improved inductive device of the invention, whether described herein or otherwise.

As shown in FIG. 7, the method 700 generally comprises first forming a termination header if required (step 702), including forming the terminals and disposing them within the header (step 704). Next, the core elements 205a, 205b, 210a, 210b are provided (step 706). Bonded wire is next provided in sufficient quantity (step 708). Per step 710, the bonded wire is then formed on an external form, and cured (e.g., heated, exposed to chemical agents, irradiated, etc.). The cured winding element is then removed from the form and prepared, which includes properly positioning the free ends of the windings and stripping them if required (step 712).

The prepared coils are then disposed between the respective core elements, the latter being optionally bonded together with adhesive or epoxy, or other methods as previously described (step 714). The assembled core is then disposed onto the termination header (if used) and optionally bonded thereto using adhesive or another means (step 716), and the free ends of the windings terminated to their respective terminals (step 718). The device is then optionally tested per step 720.

Furthermore, the methods of manufacturing (and process/component control and selection during manufacturing) described in co-pending and co-owned U.S. application Ser. No. 10/000,877 filed, Dec. 14, 2001, entitled “Controlled Induction Device and Method of Manufacturing”, incorporated herein by reference in its entirety, may be used in conjunction with the teachings of the present invention if desired to further control electrical and/or magnetic performance.

It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1. An electronic device comprising:
a plurality of core elements each defining at least a portion of two or more inductive devices; and
two or more windings adapted to fit substantially between the plurality of core elements proximate respective ones of said two or more inductive devices;
wherein said two or more inductive devices are substantially decoupled from one another.

2. The electronic device of claim 1, wherein each of said plurality of core elements further comprises two or more risers, wherein said two or more windings are each disposed about a respective one of said two or more risers.

3. The electronic device of claim 2, wherein a first and a second of said plurality of core elements each comprise a matched pair of risers within said two or more risers, said matched pair of risers comprising a gap therebetween.

4. The electronic device of claim 3, wherein a third and a fourth of said plurality of core elements each comprise a second matched pair of risers within said two or more risers, said second matched pair of risers comprising a second gap therebetween.

5. The electronic device of claim 4, wherein said first and second gaps are asymmetric.

6. The electronic device of claim 2, wherein said two or more risers are elongated.

7. The electronic device of claim 2, wherein said two or more windings comprise a bonded wire material.

8. The electronic device of claim 7, further comprising at least one separating divider wall, said separating divider wall isolating said two or more risers from one another.

9. An electronic device, comprising:
a plurality of core elements, at least one of said plurality of core elements comprising:
a substantially planar surface;
a plurality of risers protruding away from said substantially planar surface;
and
at least two edge risers protruding away from said substantially planar surface, each of said at least two edge risers resident on an edge of said substantially planar surface; and
at least one winding, said at least one winding disposed about at least one of said plurality of risers.

10. The electronic device of claim 9, wherein at least one of said plurality of core elements comprises a substantially planar core element.

11. The electronic device of claim 10, wherein said substantially planar core element is disposed on at least a portion of said at least two edge risers, said substantially planar core element forming a gap between itself and at least one of said plurality of risers.

12. The electronic device of claim 9, wherein said plurality of risers collectively comprise a two-dimensional array.

13. The electronic device of claim 9, wherein said plurality of risers collectively comprise a one-dimensional array.

14. The electronic device of claim 9, wherein at least two of said plurality of core elements, comprises:
a substantially planar surface;
a plurality of risers protruding away from said substantially planar surface; and
at least two edge risers protruding away from said substantially planar surface, each of said at least two edge risers resident on an edge of said substantially planar surface.

15. The electronic device of claim 9, further comprising a terminal array, said terminal array further comprising a plurality of terminal pins.

16. An electronic device comprising:
a plurality of core elements each defining at least a portion of two or more inductive devices; and
two or more windings adapted to fit substantially between said plurality of core elements proximate respective ones of said two or more inductive devices; and
a terminal array in electrical communication with said two or more windings.

17. The electronic device of claim 16, wherein said terminal array comprises a self-leaded terminal array.

18. The electronic device of claim 16, wherein said terminal array is adapted for surface mounting to an external substrate.

19. The electronic device of claim 18, wherein said plurality of core elements are disposed vertically such that they are substantially orthogonal with said external substrate when said electronic device is mounted on said external substrate.

20. The electronic device of claim 18, wherein said plurality of core elements are disposed horizontally such that they are substantially parallel with said external substrate when said electronic device is mounted on said external substrate.

21. A method of manufacturing an electronic device, comprising:
providing a plurality of core elements;
providing a plurality of winding conductors;
forming said winding conductors into substantially unitary winding elements, said elements substantially retaining their shape after said forming without a bobbin or support structure;
disposing said plurality of winding elements to the plurality of core elements so that the winding elements are each at least partly contained within a respective cavity that is formed around at least a portion of the plurality of core elements; and
coupling each of the plurality of core elements to at least one other of said plurality of core elements.

22. A method of operating a multi-inductor inductive device, comprising:
providing an inductive device comprising a plurality of core elements which form a plurality of gapped opposing surfaces, said gapped opposing surfaces being associated with respective ones of said inductors;
generating a first flux through said device including across a first of said gaps, said generated first flux being in a first direction; and
generating a second flux through said device including across said first gap, said generated second flux being in a second direction;
wherein said first and second fluxes flow in the same direction through said first gap.

23. The method of claim 22, further comprising:
generating a third flux through said device including across a second of said gaps, said generated third flux being in said second direction; and
generating a fourth flux through said device including across said second gap, said generated fourth flux being in said first direction;
wherein said third and fourth fluxes flow in the same direction through said second gap.

24. An inductive device having a plurality of inductive elements, the device comprising:
a first core element;
a second core element; and
at least two winding elements;
wherein said first and second core elements form at least two gapped risers, respective ones of said at least two winding elements being substantially disposed around said at least two gapped risers.

25. The inductive device of claim 24, wherein said winding elements each comprise bonded wire windings formed into a substantially unitary body.

26. The inductive device of claim 24, wherein said device comprises a plurality of flux paths when operated, said plurality of paths including substantially parallel paths of common direction through each of said at least two gapped risers.

27. The inductive device of claim 26, wherein said core elements further form a non-gapped or bridged riser, and said plurality of paths include another path through said non-gapped or bridged riser which is substantially parallel with, but of opposite direction to, said paths of said at least two gapped risers.

28. An multi-inductor inductive device, comprising:
a plurality of core elements, the core elements comprising a plurality of risers, at least a portion of said risers comprising a gap; and
a plurality of windings, said windings disposed at least partly around respective ones of said risers;
wherein said inductors are substantially electrically isolated from one another, said isolation allowing for individualized determination of saturated output power for each of the plurality of inductors.
